(19) United States
(12) Patent Application Publication
(10) Pub. No.: US 2010/0289266 A1
(43) Pub. Date: Nov. 18, 2010

(54) METHOD FOR THE OPERATION OF A WIND POWER PLANT

(75) Inventors: Svenja Wortmann, Rendsburg (DE); Thomas Kruger, Westerronfeld (DE)

Correspondence Address: RANKIN, HILL & CLARK LLP, 38210 GLENN AVENUE, WILLOUGHBY, OH, 44094-7808, US

(73) Assignee: REPOWER SYSTEMS AG, Hamburg (DE)

(21) Appl. No.: 12/809,696

(22) PCT Filed: Dec. 3, 2008
(86) PCT No.: PCT/EP2008/010225

§ 371 Date: Aug. 10, 2010

(30) Foreign Application Priority Data
Dec. 21, 2007 (DE) 10 2007 063 082.6

(51) Int. Cl. H02P 9/04

(52) U.S. Cl. 290/44

(57) ABSTRACT

A method for the operation of a wind power plant (W), wherein the wind power plant (W) has a tower (T) and a rotor with at least two rotor blades (RB1, RB2, RB3) connected with the tower, wherein each rotor blade (RB1, RB2, RB3) can be adjusted or is adjusted respectively around a rotor blade axis (RA1, RA2, RA3) with a predetermined rotor blade adjustment angle (GPW) and the rotor blades (RB1, RB2, RB3) are driven in a rotating manner by external wind movements around a rotor axis pro-vided transverse to the rotor blade axes (RA1, RA2, RA3). The rotor blade adjustment angle (GPW) for each rotor blade (RB1, RB2, RB3) is changed independently and/or individually depending on the lateral oscillations of the tower such that the amplitude of the lateral oscillations of the tower (T), induced in particular through the exterior wind movements, is damped.

### BACKGROUND OF THE INVENTION

1. Field of the Invention

The invention relates to a method for the operation of a wind power plant, wherein the wind power plant has a tower and a rotor with at least two rotor blades connected with the tower, wherein each rotor blade can be adjusted or is adjusted respectively around a rotor blade axis with a predetermined rotor blade adjustment angle and the rotor blades are driven in a rotating manner by external wind movements around a rotor axis provided transverse to the rotor blade axes. Furthermore, the invention relates to a wind power plant.

2. Description of Related Art

Wind power plants of the patent applicant are known under the description 5M, MM92, MM82, MM70 and MD77. The wind power plants erected or respectively installed at a fixed location generally have a rotor with three rotor blades attached uniformly on a rotor hub. Within a specified wind speed range, the rotor speed is controlled by means of an operating control system by adjusting the rotor blade angle to set a nominal power or respectively a specified power.

Different approaches are known for controlling the rotational speed of a rotor of a rotational-speed-variable wind power plant. Two operating states are normally hereby distinguished, namely the rotational speed regulation in partial load mode and in full load mode. Normally, so-called “torque regulation” takes place in partial load mode and so-called “pitch regulation” takes place in full load mode.

Torque regulation is a rotational speed regulation, in which the rotational speed of the system in the partial load range is adjusted to the optimal ratio between the circumferential speed of the rotor and the wind speed, in order to achieve a high power output. The power output is well described via the term power coefficient c_{P}, which is a quotient of the power input of the system to the power contained in the air movement.

The ratio of the circumferential to unhindered wind speed is called the tip speed ratio. The rotor blades are thereby set to the blade angle that generates the highest drive torque at the rotor shaft. The rotational speed is affected by the counter torque at the generator. That is, the control variable for the rotational speed regulation via the so-called torque regulation is the torque and in particular the torque at the generator, which is higher the more power the generator takes from the system or respectively the wind power plant and feeds into a network.

The rotational speed regulation called pitch regulation, which is carried out in full load mode of the wind power plant, takes place via the adjustment of the blade angle of the rotor blade. If the nominal torque is reached on the generator (nominal load) during the nominal wind speed, the rotational speed can no longer be held at the working point through a further increase in the generator torque. Thus, the aerodynamic efficiency of the blades is impaired in that they are moved out of their optimal adjustment angle. This process is called “pitching.” The rotational speed is, thus, affected via the adjustment angle of the blades once the nominal generator torque is reached.

Regulations of rotational-speed-variable wind power plants through blade adjustment (pitch regulation) and the influencing of the generator torque (torque or power regulation) are described in numerous patents and technical articles. After all, in all known methods, the rotational speed of the wind power plant is regulated. In the partial load range, it is attempted to track the rotational speed of the wind speed in order to, thus, hold the rotor at a constant blade angle at the energetically optimal operating point. In the full load range, it is attempted to keep the rotational speed and torque constant. The rotational speed is thereby regulated through variation of the blade angle.

Moreover, it is known that a wind power plant can be excited towards lateral tower oscillations through gusts or turbulent, direction-changing winds, wind shears and component asymmetries. The tower of the wind power plant thereby oscillates with the first tower natural frequency and the single and triple rotor rotational frequency.

### BRIEF SUMMARY OF THE INVENTION

Based on this state of the art, the object of the present invention is to enable safe operation of a wind power plant even in turbulent winds in the area of a wind power plant, wherein the effort for this should be kept as low as possible.

In the method for the operation of a wind power plant, wherein the wind power plant has a tower and a rotor with at least two rotor blades connected with the tower, wherein each rotor blade can be or will be adjusted around a rotor blade axis with a predetermined rotor blade adjustment angle and the rotor blades are driven in a rotating manner through external wind movements around a rotor axis provided transverse to the rotor blade axes, the object is solved in that the rotor blade adjustment angle for each rotor blade is changed independently and/or individually depending on the lateral oscillations of the tower such that the amplitude of the lateral oscillations of the tower, induced in particular through the exterior wind movements, is damped.

The invention is based on the idea of using an input parameter dependant on the oscillation stimulated by the wind movements in the range of the tower natural frequency or respectively corresponding to the oscillation in the range of the tower natural frequency, which varies during the service life, for a regulation of the rotor blade adjustment angles, wherein the natural-oscillation-dependent input parameter leads to a change in the set rotor blade adjustment angle.

Through the regulation according to the invention, the amplitude of the in particular lateral tower oscillations is reduced continuously, wherein the regulation for this individually specifies the blade angles while taking into consideration the, in particular, lateral tower movement. Thus, the lateral forces attacking the tower head are directly affected in a reaction on the deflections of the tower through the executed individual adjustments of the rotor blades, which can also be executed independently of each other, so that the oscillations of the tower are damped. The blade angle, or respectively the rotor blade adjustment angle, is thereby selected such that the resulting laterally acting forces on the tower counteract the tower oscillation. The adjustment or respectively the setting of the rotor blade angle of the rotor blades is preferably executed through hydraulic or electric or respectively electromechanical rotor blade adjustment systems or respectively units or devices.

When oscillations in the range of the tower natural frequency(ies) are discussed in this context, then within the framework of the disclosure of the invention it is or refers to oscillations in the range of the in particular lateral tower natural frequency(ies) of ±25%, in particular ±10%, more preferably ±5%, of the natural frequency(ies), preferably of the lateral tower natural frequencies. In particular, lateral oscillations in the range of the first and if applicable also the second lateral (tower) natural frequencies are taken into consideration for the damping of the lateral oscillations of the tower. Within the framework of the invention, lateral oscillations in the range of the higher (lateral) tower natural frequencies can also be taken into consideration.

The lateral oscillations to be damped are primarily oscillations of the tower, which are induced by external gusty wind conditions or respectively by wind gusts. These lateral oscillations of the tower brought about by wind gusts, which are not generated or respectively do not occur under normal conditions, were hardly or not at all or insufficiently damped up to now, so that in the long term during operation of a wind power plant impairments occur with respect to the stress of mechanically loaded components, which lead to permanent damage of the wind power plant in the case of insufficient and untimely detection and, thus, endanger the operation of the system. Overall, safe operation of the wind power plant in turbulent winds or wind gusts is achieved through the lateral oscillation damping of the tower according to the invention.

It is further suggested that, through the individual changes in the rotor blade angle of the rotor blades, a lateral force is generated in the rotor, through which the lateral oscillations of the tower, in particular oscillations in the range of a lateral natural oscillation frequency of the tower, are damped.

In particular, the lateral force or respectively the magnitude of the lateral force is generated depending on the amplitude(s) of the lateral oscillations of the tower in the range of the lateral tower natural frequency or respectively is the size of the generated lateral force depending on the amplitude of the lateral tower oscillation of the tower in the range of the lateral tower natural frequency, i.e. the lateral natural frequency of the tower.

It is hereby further advantageous if the rotor blade adjustment angles of the rotor blades are changed or adapted such that the lateral force generated in the rotor is changed periodically. The amplitude of the lateral oscillations of the tower of the wind power plant are thereby reduced or respectively damped in a targeted and corresponding manner.

Moreover, a further embodiment of the method is characterized in that the lateral force generated in the rotor is periodically changed with a frequency, wherein in particular the frequency lies in the range of the lateral tower natural frequency.

In order to damp the lateral oscillations of the tower of a wind power plant in an advantageous manner, the phase position of the periodic change in the created lateral force of an, in particular, dynamic control device is adjusted such that the lateral force counteracts the lateral tower natural oscillation. A phase shift in the regulation of the lateral oscillation damping is hereby achieved or respectively designed, wherein (temporal) delays or respectively the signal delay times of the pitch system (rotor blade adjustment system) and dynamic properties of the tower or other relevant parameters, which directly or indirectly affect the lateral oscillations, such as the stiffness or the mass inertia of towers, the nacelle, the rotor and dynamic and/or aerodynamic effects or respectively parameters or operating parameters etc. are hereby taken into consideration.

In accordance with one embodiment, the rotor blade adjustment angle of the rotor blades is corrected for each rotor blade by means of an adjustment angle correction value dependant on the oscillation in the range of the natural oscillation frequency of the tower so that a new rotor blade adjustment angle is determined individually for each rotor blade. A dynamic and timely regulation for the damping of the lateral oscillations of the tower hereby results during the service life of the wind power plant, wherein the adjustment or respectively changes in the rotor blade angles take(s) place in predetermined periods.

If there are several rotor blades on a wind power plant, it is provided according to another embodiment that, after determination of the new individual rotor blade adjustment angles of each rotor blade, the rotor blades are adjusted with the associated new determined rotor blade adjustment angle. For several rotor blades, the corresponding rotor blade adjustment angle is corrected by means of, respectively, an individual predetermined adjustment angle correction value so that a new individual corrected rotor blade adjustment angle is determined for each rotor blade.

Accordingly, after determination of the new individual rotor blade adjustment angles, each rotor blade is adjusted with the associated new individual rotor blade adjustment angle. Through the individual determination and setting of the corresponding rotor blade adjustment angles, the corresponding position of the rotor blades around the rotor axis is, for example, taken into consideration, whereby an individual blade adjustment is carried out and thus influence is exerted in a targeted manner on the lateral forces attacking the tower and exciting the oscillation. Through the corresponding independent adjustment of the individual rotor blades, the lateral tower oscillation is damped in the desired manner during the operation of the wind power plant.

Furthermore, the method is characterized in that the individual rotor blade adjustment angles of the rotor blades are changed or set continuously and/or regularly during the rotation of the rotor blades around the rotor axis.

Moreover, it is provided in a further embodiment of the method that the oscillation in the range of the natural oscillation frequency of the tower and the individual rotor blade adjustment angles are determined continuously and/or regularly, preferably at predetermined time intervals, during the operation of the wind power plant in order to, thus, execute a dynamic adjustment or respectively regulation of the actuating variables, which lead to a lateral oscillation of the tower and to damp the lateral deflections of the tower.

Furthermore, it is preferred in one embodiment of the method that the rotor blade adjustment angles of the rotor blades are changed continuously depending on the determined current oscillation in the range of the natural oscillation frequency of the tower.

Furthermore, the rotor blade adjustment angles of the rotor blades are preferably changed depending on the rotor blade positions of the rotor blades rotating around the rotor axis.

Advantageously, the oscillations in the range of the natural oscillation frequency of the tower are recorded by means of at least one acceleration sensor, wherein for this the acceleration sensor is advantageously provided in or respectively assigned to the nacelle of a wind power plant, which is or will be arranged on the tower. In particular, corresponding acceleration sensors are arranged in the tower head, in order to capture the lateral oscillations of the tower.

The method is also characterized in that a maximum blade adjustment angle correction value is determined based on the recorded oscillations in the range of the natural oscillation frequency of the tower and of a predetermined, in particular individual, amplification factor for each tower. This maximum blade adjustment angle is determined for the calculation or respectively the determination of a new blade adjustment angle taking into consideration the position of the rotor blades around the rotor axis in order to bring about a corresponding change in the rotor blade.

The maximum blade adjustment angle correction value is thereby dependent on the temporal development of the oscillation in the range of the natural oscillation frequency of the tower. With a specified rotor blade angle for all rotor blades, the corresponding rotor blade angle position is provided as the answer to the dynamic properties of the wind and the dynamic properties of the tower induced by the wind movement.

Furthermore, the object is solved through a wind power plant, which is designed for the implementation of the method according to the invention described above. We expressly refer to the above explanations in order to avoid repetitions.

### BRIEF DESCRIPTION OF THE DRAWINGS

The invention is described below in an exemplary manner based on an exemplary embodiment in reference to the drawings, whereby we expressly refer to the drawings with regard to the disclosure of all details according to the invention that are not explained in greater detail in the text. The drawings show in:

FIG. 1 a schematic view of a circuit diagram according to the invention;

FIG. 2 schematically a block circuit diagram for the generation of an excitation equivalence from a lateral tower acceleration;

FIG. 3 in the left part the schematic progression of various physical parameters and in the right part a drafted front view of a wind power plant;

FIG. 4 schematically the progression of the lateral tower positions with and without damping of the lateral tower oscillations and

FIG. 5 schematically the temporal progression of the tower natural frequency and rotational frequency of the rotor.

### DETAILED DESCRIPTION OF THE INVENTION

In the following figures, the same or similar types of elements or respectively corresponding parts are provided with the same reference numbers in order to prevent the item from needing to be reintroduced.

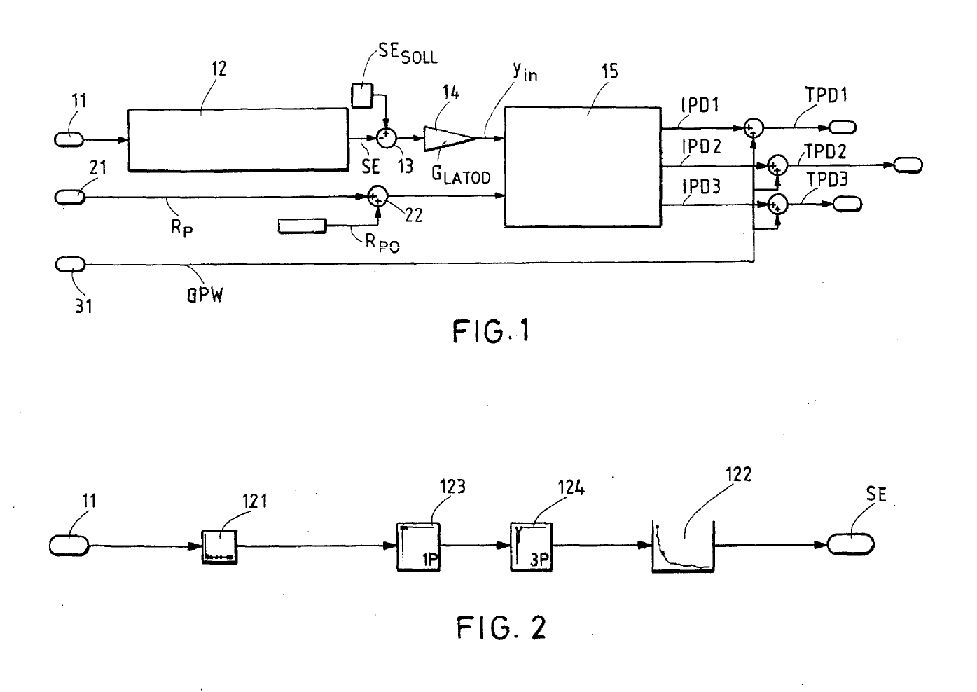

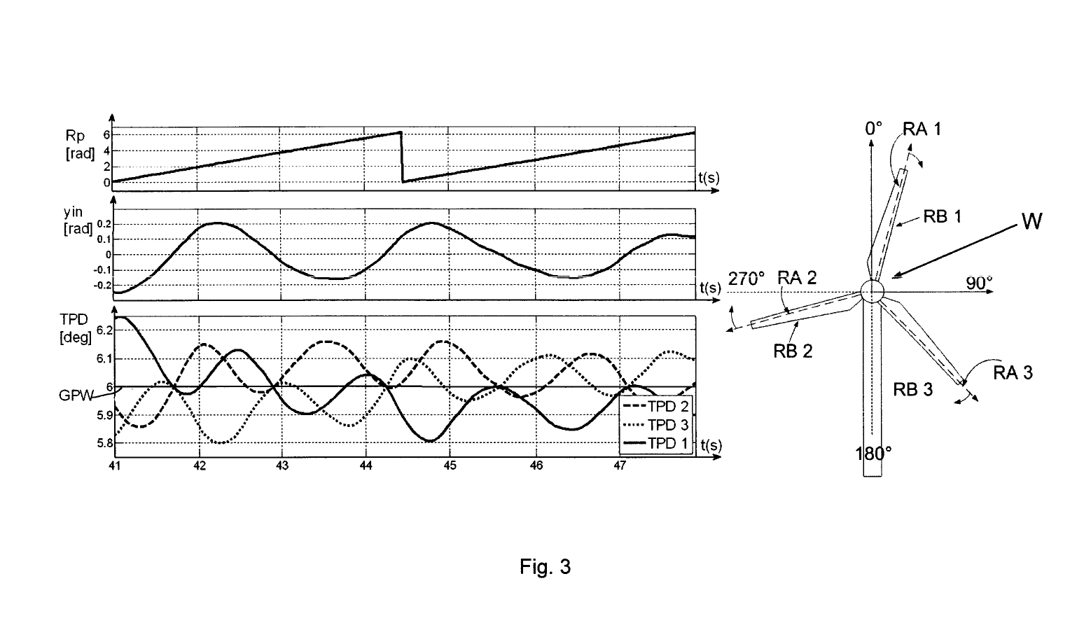

FIG. 1 shows schematically a circuit diagram, in accordance with which the individual rotor blade adjustment angles TPD1, TPD2 and TPD3 are determined for corresponding rotor blades RB1, RB2 and RB3 of a wind power plant W (see FIG. 3).

In this exemplary embodiment, a wind power plant W (type MM) hereby has a three-blade rotor, as shown in the right part of FIG. 3. The rotor thereby has the rotor blades RB1, RB2 and RB3 and is arranged on a tower T or respectively the tower head. The rotor rotational axis is designed perpendicular to the drawing plane. The rotor blades RB1, RB2 and RB3 are arranged in a rotatable manner on the rotor around their rotor blade axes RA1, RA2 and RA3. By means of a corresponding adjustment apparatus, the rotor blades RB1, RB2 and RB3 are set with a predetermined common rotor blade angle GPW.

The lateral acceleration of the tower T or respectively of the tower head is captured by means of an acceleration sensor 11 (see FIG. 1), which is arranged, for example, in the nacelle of a wind power plant W.

The acceleration sensor 11 transfers its measurement signals to an evaluation unit 12, by means of which an excitation variable SE or adjustment amplitude is determined, which correlates with the measured acceleration of the acceleration sensor 11. In particular, the oscillation-dependent excitation variable SE is hereby measured continuously during the operation of the wind power plant. By means of the evaluation unit 12, an excitation variable SE is determined, in particular, which depends on the lateral tower acceleration or respectively tower movement (tower oscillation). The generation of the excitation variable SE or respectively of the excitation equivalence from the lateral tower acceleration is shown schematically in FIG. 2.

The measurement signals of the acceleration sensor 11 are hereby filtered in the evaluation unit 12 with respect to a first tower natural frequency by means of a band-pass filter 121 and subsequently shifted in the phase by means of a phase shift member 122 such that the excitation variable SE results.

Optionally, as shown in FIG. 2, the 1P and 3P frequencies can be filtered out of the lateral tower acceleration signal by means of a notch filter 123 or several notch filters 123, 124 after the filtering of the natural frequency through the band pass 121. The sensor signals are hereby filtered by means of filters 123, 124, wherein filters 123, 124 have a (good) transmittance permeability in the range of a lateral tower natural frequency, in particular of the first tower natural frequency and if applicable of higher lateral tower natural frequencies.

Through the phase shift executed by the phase shift member 122, through which the excitation variable SE is affected, it is possible in the case of the excitation variable to take into consideration the (temporal) delays of the pitch system or the signal delay times as well as the dynamics or respectively the mechanical (and dynamic) properties, such as the stiffness and/or the mass inertias of important components of the wind power plant (tower, nacelle, rotor, etc.), which affect the lateral oscillations of the tower, or of other variables such as the aerodynamics or dynamic as well as aerodynamic (operating) parameters in the corresponding manner and to include them in the active damping of the lateral oscillations according to the invention for the adjustment amplitude in order to maximize the damping effect.

The use of notch filters 123, 124 is carried out in particular when it is assumed that the frequent occurrence of so-called 1P and 3P frequencies is anticipated during operation of the wind power plant.

In a simple embodiment, the interconnection of notch filters 123, 124 between the band pass 121 and the phase shift member 122 is omitted. A faster decay of the excited oscillation of the tower is achieved through the phase shift member 122 or respectively the phase-shifted excitation variable SE.

The excitation variable SE determined in the evaluation unit 12 or respectively the stimulation equivalent is subsequently compared with the setpoint value SE_{SOLL} of the excitation variable SE in a comparator device 13, wherein the difference of the two values is determined.

In the present exemplary embodiment, the setpoint value SE_{SOLL} of the excitation variable SE is set to 0 (zero), since the tower oscillation needs to be damped, whereby the excitation must be reduced to zero or respectively the oscillation or respectively the oscillation amplitude of the tower needs to be damped. The following equation hereby applies in particular:

yₘ=(SE_{SOLL}−SE)*G_{LATOD}=−SE*G_{LATOD}

In particular, in accordance with the invention, a linear connection between the adjustment amplitude and the measured acceleration(s) is preferred.

In this setpoint/actual value comparison, the amplification factor G_{LATOD} amplifies the error variable. The amplification of the setpoint/actual value comparison with the variable G_{LATOD} is carried out in the amplification unit 14.

Under the assumption that the setpoint value SE_{SOLL} of the excitation variable SE is set to 0 (zero), the signal yᵢₙ is given as the natural-frequency-dependent input parameter to a transformation unit 15.

The optimal amplification or respectively the amplification factor G_{LATOD} is thereby dependent on the tower properties like the first tower frequency and the amplification of the acceleration signal through the previous signal processing. In particular in the case of the amplification factor G_{LATOD}, oscillation-relevant actuating variables and/or specific properties of the tower are taken into consideration. For example, an optimal amplification for G_{LATOD} of approximately 4.5°/(m s²) results for an examined wind power plant of type MM of the patent applicant.

It is thereby assumed for the excitation variable or respectively the excitation equivalent SE that the measured lateral tower acceleration must be clearly shifted in the phase in order to achieve an effective and fast lateral oscillation damping. The optimal phase shift of the excitation variable SE hereby depends on the delay from the so-called pitch system and the tower properties as well as the first tower natural frequency.

For example, an overall phase shift of the lateral tower acceleration of 70° to 80° with respect to the tower oscillation frequency was determined to be optimal for an MM wind power plant of the patent applicant with a first tower natural frequency of approximately 0.3275 Hz and a delay of approximately 300 ms through the pitch system. Another phase shift by 180° and a feeding of an inverse signal are also conceivable. This phase shift can be generated either by the filters, by supplying the rotor position with an offset or a combination of the two.

In another embodiment, the acceleration signal is already filtered in advance for the elimination of measurement noises etc., wherein phase shifts potentially caused by this should be taken into consideration.

The amount of the optimal phase shift is advantageously determined by simulation calculations, in which the phase shift and the amplification G_{LATOD} are optimized such that a (sufficient) predetermined or respectively predeterminable damping with minimum control activity results. Methods for parameter optimization can be used for this. Alternatively, the controller settings can also be optimized through field tests, although this is time consuming.

Moreover, the transformation unit 15 receives rotor position R_{P} measured by a sensor 21 as another input parameter, which is supplied with an offset of the rotor position R_{PO} in an optional operating unit 22. The offset of the rotor position can hereby be predetermined or respectively is freely selectable.

The individual adjustment angle correction values IPD1, IPD2, IPD3 are determined from the input parameters yᵢₙ and the (optionally changed) rotor position ωt=R_{P}+R_{PO} in the transformation unit 15 by means of a rotation transformation. The rotor position is superimposed by a mainly sinusoidal oscillation of the acceleration signal. This results in a constantly changing phase shift between the rotor position and the maximum blade angle (since no oscillation with rotor rotational speed).

The following equations hereby apply for the individual adjustment angle correction values IPD1, IPD2, IPD3 while taking the determined tower natural frequency into consideration:

$$\begin{matrix}IPD 1 = {{y}_{m}}^{*} cos ( ω t ) & ( for rotor blade RB1 ) \\ IPD 2 = {{y}_{m}}^{*} cos ( ω t - \frac{2}{3} π ) & ( for rotor blade RB2 ) \\ IPD 3 = {{y}_{m}}^{*} cos ( ω t + \frac{2}{3} π ) & ( for rotor blade RB3 )\end{matrix}$$

The individual total blade adjustment angle for each rotor blade RB1 RB2 and RB3 results from the addition to the collective or respectively common blade adjustment angle GPW, specified from a pitch regulation 31, for each individual rotor blade.

The new rotor blade adjustment angles TPD1, TPD2 and TPD3, thus result after filtering of the lateral acceleration signals with a band pass and the shifting of the phase by means of low pass for the different three rotor blades RB1, RB2, RB3 as follows:

$$\begin{matrix}TPD 1 = GPW - {SE}^{*} {{G}_{LATOD}}^{*} cos ( ω t ) & ( for RB1 ) \\ TPD 2 = GPW - {SE}^{*} {{G}_{LATOD}}^{*} cos ( ω t - \frac{2}{3} π ) & ( for RB2 ) \\ TPD 3 = GPW - {SE}^{*} {{G}_{LATOD}}^{*} cos ( ω t + \frac{2}{3} π ) & ( for RB3 )\end{matrix}$$

Moreover, in another embodiment of the regulation of the rotor blade adjustment angle, the maximum angle difference between the individual rotor blades is limited to a few degrees in order to avoid movements of the rotor blades or respectively pitch movements that are too large. The upper and lower limit for the adjustment movements of the rotor blades are predetermined with respect to the rotor and tower load and loads of the rotor blade adjustment system. It was shown in experiments that this type of limit for the rotor angle adjustment correction values may possibly not be needed. This depends, for example, on the properties of the wind power plant.

In order to keep the additional wear and tear for the blade adjustment system low, it proved to be advantageous to activate the method according to the invention only when needed.

On one hand, use is advantageously limited to critical operating ranges. In onshore systems, these are e.g. switching on and shut-down of the rotor with pass through of the lateral tower natural frequency and the nominal power range. The activation in the nominal power range can be carried out e.g. advantageously directly through the generator power, e.g. upon exeedance of 90% or 95%, in particular also 98% or 99.5% of the nominal power. Alternatively, the activation can also be carried out through monitoring of the collective blade angle or respectively depending on the common blade adjustment angle GPW. A corresponding regulation according to the invention is activated in a suitable manner with a common blade adjustment angle GPW from a value of GPW≧1° or 2° to 8°, in particular 3°, 4°, or 5°.

In offshore systems, another critical operating condition is when waves transverse to the wind direction act on the support structure of a wind power plant. This can be detected through wave sensors that activate regulation according to the invention depending on the wave direction (relative to the wind) and wave height.

Moreover, the use of the regulation is advantageously restricted to the exceedance of a predetermined oscillation level, i.e. a deadband of the oscillation of the tower is added in a controlled manner, to which the controller or respectively the control device does not react. Depending on the stiffness of the tower and other variables of the (dynamic) properties of the wind power plant or respectively of the tower, which affect the lateral oscillations, advantageous threshold values for a measured tower head acceleration, and/or the properties of the blade adjustment system can be in the range of 0.01 m/s² and 0.6 m/s², in particular 0.2 m/s² or 0.3 m/s². This measure also prevents the default of amplitudes of oscillating blade adjustment angles that are too small and which cannot then be provided based on the gearbox play in the blade adjustment drives.

In accordance with the invention, the self-adjusting individual rotor blade angle should always be large enough that no so-called stall effects, i.e. the stalling of the circulation of the rotor blade, occur in the system. The change or respectively the temporal change of the rotor blade adjustment angles is advantageously restricted to the maximum rates permitted by the pitch system.

FIG. 3 shows in the left area schematically and in an exemplary manner the temporal progression of the rotor position R_{P} [rad] and of the input parameter yᵢₙ [rad] and the correspondingly calculated rotor blade adjustment angle TPD1 for the rotor blade RB1, the rotor blade adjustment angle TPD2 for the rotor blade RB2 and the rotor blade adjustment angle TPD3 for the rotor blade RB3 in a collective and constant pitch angle GPW.

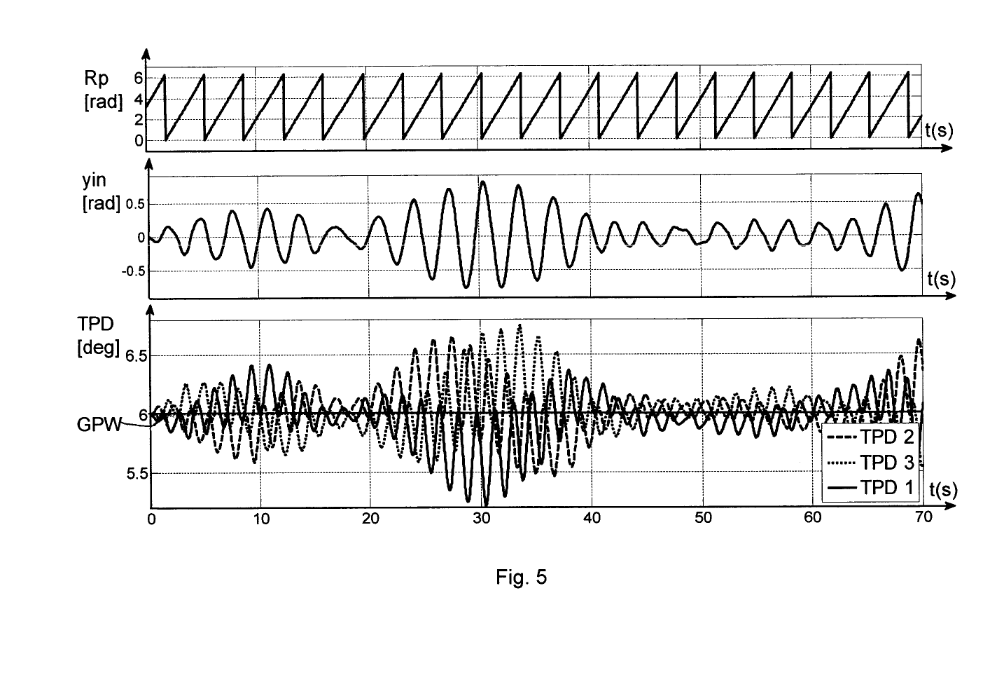

FIG. 5 shows the same interrelations as in FIG. 3 for a longer period of time. It can be seen how the superimposition of the tower natural frequency and the rotor rotational frequency lead to constantly changing phase shifting between rotor position and maximum blade angle: at time t=20 s, the blade angle of rotor blade RB1 is at rotor position 6 rad approx. at a maximum, 10 seconds later at t=30 s with the same rotor position approx. at a minimum.

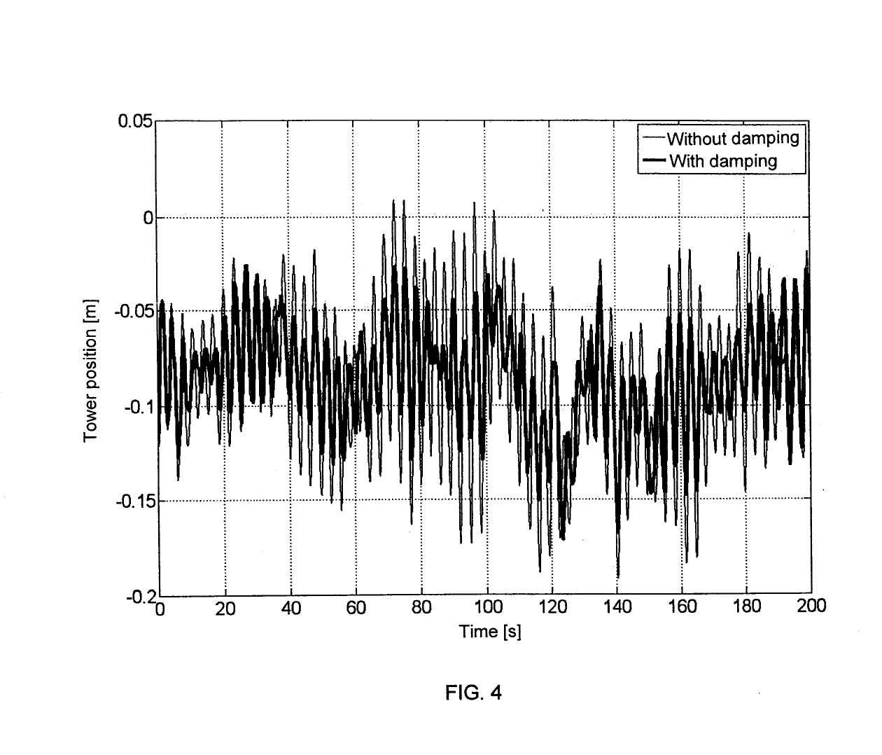

It has been shown in practice that, through the individual rotor blade adjustment angles, in which the rotor blade adjustment angles have been set due to the tower natural frequency taken into consideration, the tower positions fluctuate much less in their deflections or respectively amplitudes over time, as shown for example in FIG. 4.

The curve drawn in FIG. 4 with the thinner lines shows the lateral progression of the tower position of a wind power plant without damping while the thicker line shows the progression of the lateral tower position with damping of the lateral tower oscillations.

Through the significant damping of the lateral tower oscillations in nominal mode, it is achieved that the wind power plant is operated without relevant interference of the longitudinal tower movements and the electrical power outputs. The blade angles thereby oscillate very slightly with less than ±1°

Through the use of the regulation according to the invention, it is achieved that the number of shutdowns of the wind power plants due to strong lateral oscillations of the towers is reduced, whereby the yield for the generation of electrical power is increased. It is also achieved that the reduction in the fatigue loads on the tower through lateral tower oscillations in the nominal range and also during shutdowns leads to an increase in the service life or respectively to material savings during the erection and operation of a wind power plant.

Since the oscillations in the range of the natural frequency of the tower are determined during operation, the individual determined rotor blade adjustment angles, preferably within a predetermined angle range of e.g. 1°, 2°, 3°, 4° or 5°, lead to a reduction in the lateral oscillations of the tower during the entire service life of the wind power plant.

### LIST OF REFERENCES

11 Acceleration sensor
12 Evaluation unit
13 Comparator device
14 Amplification unit
15 Transformation unit
31 Pitch regulation
121 Band pass
122 Phase shift member
123 Notch filter
124 Notch filter
SE Excitation variable
SE_{SOLL} Setpoint value
G_{LATOD} Amplification factor
yᵢₙ Input value
R_{P} Rotor position
R_{PO} Rotor position (offset)
IPD1, IPD2, IPD3 Adjustment angle correction value
RB1 Rotor blade 1
RB2 Rotor blade 2
RB3 Rotor blade 3
RA1, RA2, RA3 Rotor blade axis
GPW Common blade adjustment angle
W Wind power plant
T Tower

1. Method for the operation of a wind power plant (W), wherein the wind power plant (W) has a tower (T) and a rotor with at least two rotor blades (RB1, RB2, RB3) connected with the tower, wherein each rotor blade (RB1, RB2, RB3) can be adjusted or is adjusted respectively around a rotor blade axis (RA1, RA2, RA3) with a predetermined rotor blade adjustment angle (GPW), comprising the steps of:
driving the rotor blades (RB1, RB2, RB3) in a rotating manner through external wind movements around a rotor axis provided transverse to the rotor blade axes (RA1, RA2, RA3), and
changing the rotor blade adjustment angle (GPW) for each rotor blade (RB1, RB2, RB3) independently and/or individually depending on the lateral oscillations of the tower such that the amplitude of the lateral oscillations of the tower (T), induced in particular through the exterior wind movements, is damped.

2. The method according to claim 1, wherein a lateral force is created in the rotor through the individual changes of the rotor blade adjustment angle (GPW) of the rotor blades (RB1, RB2, RB3), through which the lateral oscillations of the tower (T), in the range of a lateral natural oscillation frequency of the tower (T), are damped.

3. The method according to claim 2, wherein the magnitude of the lateral force is generated depending on the amplitude of the lateral oscillation of the tower in the range of the lateral tower natural frequency.

4. The method according to claim 2, wherein the rotor blade adjustment angles (GPW) of the rotor blades (RB1, RB2, RB3) are changed such that the lateral force created in the rotor is changed periodically.

5. The method according to claim 2, wherein the lateral force is periodically changed with a frequency, wherein the frequency lies in the range of the lateral tower natural frequency.

6. The method according to claim 5, wherein the phase position of the period change in the lateral force is adjusted by a control device such that the lateral force counteracts the lateral tower natural oscillation.

7. The method according to claim 1, wherein the rotor blade adjustment angle (GPW) of the rotor blades (RB1, RB2, RB3) is corrected for each rotor blade (RB1, RB2, RB3) by means of an adjustment angle correction value (IPD1, IPD2, IPD3) dependant on the oscillation in the range of the natural oscillation frequency of the tower so that a new rotor blade adjustment angle (TPD1, TPD2, TPD3) is determined for each rotor blade (RB1, RB2, RB3).

8. The method according to claim 7, wherein, after determination of the new individual rotor blade adjustment angles (TPD1, TPD2, TPD3) of each rotor blade (RB1, RB2, RB3), the rotor blades (RB1, RB2, RB3) are set with the associated new determined rotor blade adjustment angle (TPD1, TPD2, TPD3).

9. The method according to claim 7, wherein the individual rotor blade adjustment angles (TPD1, TPD2, TPD3) of the rotor blades (RB1, RB2, RB3) are changed or set continuously and/or regularly during the rotation of the rotor blades (RB1, RB2, RB3) around the rotor axis.

10. The method according to claim 1, wherein the oscillations in the range of the natural oscillation frequency of the tower (T) are determined continuously and/or regularly, at predetermined time intervals during the operation of the wind power plant (W).

11. The method according to claim 1, wherein the rotor blade adjustment angles (TPD1, TPD2, TPD3) of the rotor blades (RB1, RB2, RB3) are changed continuously depending on the determined current oscillation in the range of the natural oscillation frequency of the tower (T).

12. The method according to claim 1, wherein the rotor blade adjustment angles (TPD1, TPD2, TPD3) of the rotor blades (RB1, RB2, RB3) are changed depending on the rotor blade positions (RP) of the rotor blades (RB1, RB2, RB3) rotating around the rotor axis.

13. The method according to claim 1, wherein the oscillations in the range of the natural oscillation frequency of the tower (T) are recorded by means of at least one acceleration sensor (11).

14. The method according to claim 1, wherein a maximum blade adjustment angle correction value is determined based on the recorded oscillations in the range of the natural oscillation frequency of the tower (T) and an amplification factor (GLATOD) predetermined for each tower (T).

15. Wind power plant for the implementation of the method according to claim 1.
